(19) United States
(12) Patent Application Publication
(10) Pub. No.: US 2006/0293047 A1
(43) Pub. Date: Dec. 28, 2006

(54) Data signaling channel within a digital spreading signal

(76) Inventors: Ralph Eric Tischler, Richmond (CA); Sukhdeep Hundal, Surrey (CA)

Correspondence Address: PILLSBURY WINTHROP SHAW PITTMAN, LLP, P.O. BOX 10500, MCLEAN, VA, 22102, US

(21) Appl. No.: 11/451,338

(22) Filed: Jun. 13, 2006

Related U.S. Application Data
(60) Provisional application No. 60/689,557, filed on Jun. 13, 2005.

(51) Int. Cl. H04Q 7/20

(52) U.S. Cl. 455/426.1

(57) ABSTRACT

A method and system for transmitting and receiving a control data signal within spreading signal and an intelligence/analog signal. The control data is interleaved within the spreading data signal at a transmitter side. Before transmitting to a remote receiver side, the spreading/control data signal, after passing a high-pass filter, and an intelligence signal, which is passing through a low-pass filter, are summed by a summing device to form a composite intelligence/spreading data (CISS)signal and are modulated on an RF carrier by a modulator. After receiving the CISS modulated RF carrier, the receiver side converses the CISS modulated RF carrier to IF signal, which is then demodulated by a demodulator to recover the original CISS signal. The CISS signal is then passing through a low-pass filter to recover the intelligence signal and through a high-pass filter to recover the spreading/control signal. The control signal is further recovered by a digital device.

This application claims the benefit of U.S. Provisional Application No. 60/689,557, filed Jun. 13, 2005, which is herein incorporated by reference in its entirety.

### BACKGROUND OF THE INVENTION

1. Field of the Invention

Embodiments of the present invention relate to digital spread spectrum communications. More particularly, embodiments of the present invention relate to systems and methods for enhancing a spreading signal to incorporate an intelligent data signaling channel.

2. BACKGROUND INFORMATION

Traditionally spread spectrum systems employ a separate intelligence signal, which is combined continuously in real time with a digital spreading code that modulates a radio frequency (RF) carrier to provide the transmitted spread spectrum signal. In the case where the intelligent signal channel is used for a continuous analog signal transmission, such as voice band audio, the only way to transmit control data to a remote unit is to interrupt the analog signal channel and transmit the control data. This interruption of the intelligence signal channel is undesirable.

Known spread spectrum systems are disclosed in U.S. Pat. Nos. 6,314,128, 5,673,323, 4,639,932, 4,351,064, 5,121,407, 6,256,337, 6,005,886, 4,351,064, 5,892,792, 6,128,510, 5,150,377, 5,511,090 and reissued RE35209.

In view of the foregoing, it can be appreciated that a substantial need exists for systems and methods that can advantageously enhance a spreading signal to incorporate an intelligent data signaling channel.

### SUMMARY OF THE INVENTION

Embodiments of the invention provide a method for transmitting a data control signal within a spreading data channel used in a cordless telephone system. The preferred method of the invention includes generating the spreading data signal using a spreading generator, and interleaving the control data channel signal into the spreading data signal to produce a spreading/control data signal, wherein the spreading data signal is suppressed when the control data signal is interleaved into the spreading data signal and is resumed after the interleaving process is completed. Alternatively, the control signal is used to substitute a portion of the spreading data system.

Other embodiments of the invention provide a method for transmitting a spreading data signal, an intelligence signal, and a control data channel signal. For example, an exemplary method of the invention includes generating the spreading data signal using a spreading generator, interleaving the control data channel signal into the spreading data signal to produce a spreading/control data signal, wherein the control data channel has a defined time interval, high-pass filtering the spreading and control data signal to produce a high-pass filtered spreading data signal, low-pass filtering the intelligence signal to produce a low-pass filtered intelligence signal, summing the high-pass filtered spreading and control data signal and the low-pass filtered intelligence signal to produce a composite spreading data/control data signal and intelligence signal, and modulating the composite intelligence/spreading data signal on an RF carrier. Preferably, the intelligence signal and the spreading/control signal of the intelligence/spreading data signal are separated in frequency domain.

Other embodiments of the invention further provide a method for receiving an intelligence signal and a control data channel signal from a composite intelligence/spreading data signal modulated on an RF carrier. An exemplary method of the invention includes converting the composite intelligence/spreading data signal modulated RF carrier down to an intermediate frequency (IF) signal, demodulating the intermediate frequency signal to retrieve the composite intelligence/spreading data signal, wherein a spreading signal in the composite spreading data includes the control data signal, low-pass filtering the composite spreading data signal and intelligence signal to retrieve the intelligence signal, high-pass filtering the composite spreading data signal and intelligence signal to retrieve a spreading and control data signal, and passing the spreading and control data signal through a digital device to recover the control data channel signal.

### BRIEF DESCRIPTION OF THE DRAWINGS

FIG. 1 is a schematic diagram showing a system for transmitting and receiving a spreading and control data signal and an intelligence signal, in accordance with an embodiment of the present invention.

FIG. 2 is an exemplary digital spreading signal waveform, in accordance with an embodiment of the present invention.

FIG. 3 is an exemplary control channel signal waveform, in accordance with an embodiment of the present invention.

FIG. 4 is an exemplary waveform showing a control channel signal inserted into a digital spreading signal, in accordance with an embodiment of the present invention.

FIG. 5 is an exemplary plot of waveform amplitude and frequency showing an intelligence signal frequency occupation as a result of low-pass filtering, in accordance with an embodiment of the present invention.

FIG. 6 is an exemplary plot of waveform amplitude and frequency showing a spreading and control data signal frequency occupation as a result of high-pass filtering, in accordance with an embodiment of the present invention.

FIG. 7 is an exemplary plot of waveform amplitude and frequency showing a composite spreading data signal and intelligence signal frequency occupation as a result of low-pass filtering and high-pass filtering, in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

One embodiment of the present invention is a method for enhancing a spreading signal to incorporate an intelligence data signaling channel. In this method, the intelligence information is not combined together with the spreading data channel in real time. Instead a control data actually interrupts and replaces the spreading data for a defined time interval. During this time, the control data actually acts as the digital spreading data source. After the transmission of the control data, the spreading data signal transmission is resumed. The nature and frequency of the control data is such that it still maintains the requirements for RF spreading of the lower frequency intelligence channel information.

Another embodiment of the present invention is intended to enhance the capability of an existing analog cordless telephone to incorporate spread spectrum technology to enhance the security of the analog telephone, to be able to qualify under the Federal Communications Commission (FCC) part 15 rules under the category of digital modulation, and to be able to transmit control data within the spreading data channel. Enhancement of the security of the analog phone is accomplished by the addition of the digital spreading to the analog modulated signal, making it more difficult for a conventional scanner or other cordless telephone to listen in to a conversation. Qualification under the FCC part 15 rules under the category of digital modulation allows transmission at higher output power and extended range. Transmitting control data within the spreading data channel provides enhanced capability within a cordless system to communicate system and status information without interrupting the audio or intelligence information channel.

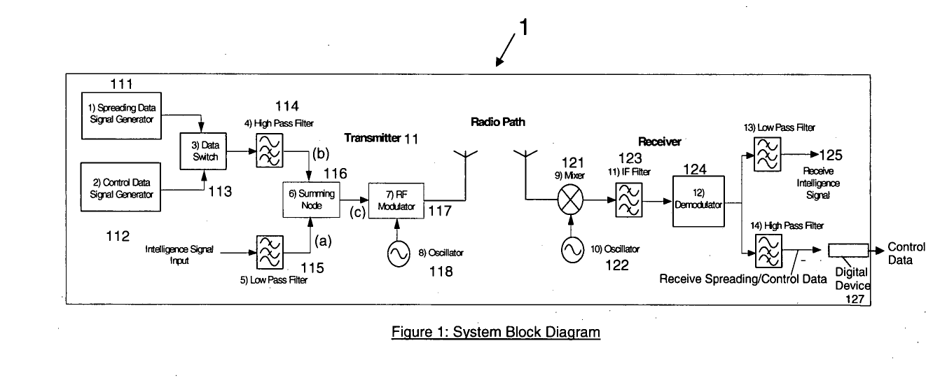

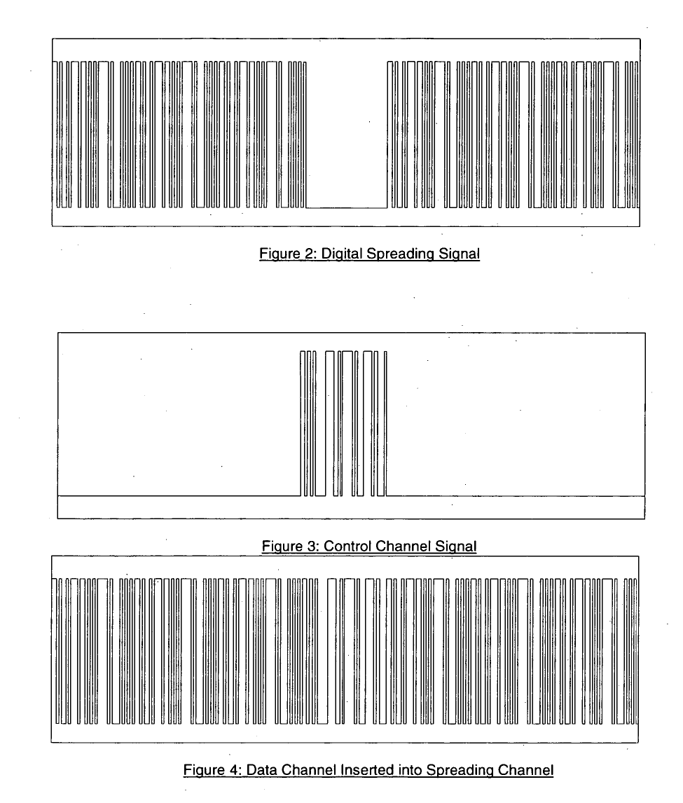

FIG. 1 illustrates a system 1 for transmitting and receiving a spread data signal and an intelligence signal in accordance with the present invention. System 1 includes a transmitter side 11 and a receiver side 12. At transmitter side 11, as described above, a control data signal is combined into a spreading data signal instead of an intelligence signal as conventional. As shown in FIG. 1, a spreading data signal and a control data signal are generated by a spreading data signal generator 111 and a control data signal generator 112, respectively. The control data signal is then interleaved into the spreading data signal. The spreading data signal may be repetitive or pseudo-random in nature, as illustrated in FIG. 2. The waveform of the spreading data signal contains no intelligence information and is used only for the function of spreading the intelligence signal when modulated onto an RF carrier. Preferably, at periodic intervals, the waveform of the spreading data signal is suppressed to allow for an interleaving of the control data signal, of which a waveform is illustrated in FIG. 3. The control data signal has a defined signal length and contains a pre-determined security code so that the control data signal can be differentiated from the spreading data signal at a receiver side. The remaining portion of the control data signal contains, in the form of a digital code, the actual system control or status information, which is utilized by the remote device that incorporates the receiver.

Data switch 113 is used to suppress the spreading signal channel and to allow the control data channel signal to be passed. An interleaved spreading and data channel waveform is shown in FIG. 4 and is present at the output of the data switch. The characteristics of the spreading and control data sequence are designed to reduce the lower frequency content which overlaps with the intelligence frequency band.

In addition to interleaving the control data into the spreading data signal, the control data signal may also substitute a portion of the spreading data signal. The substitution may also be controlled by data switch 113.

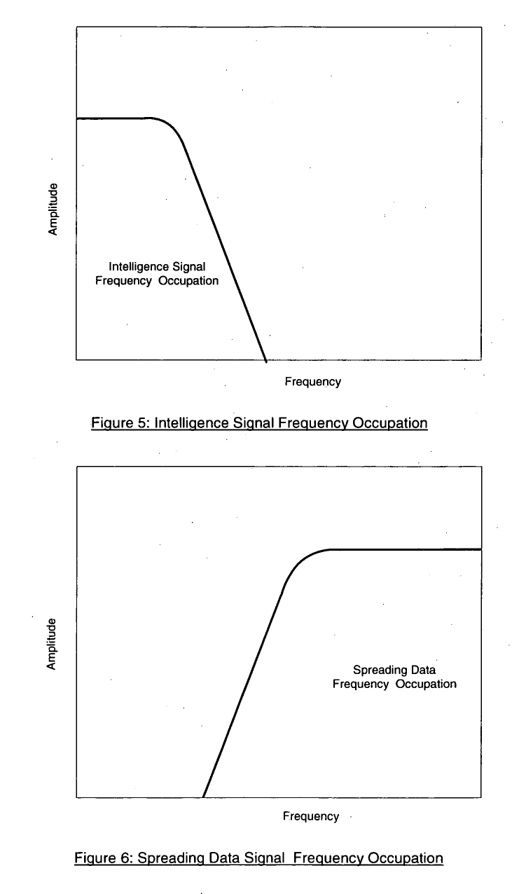

System 1 further includes a high-pass filter 114 and a low-pass filter 115. As the spreading and control data signal is assume to be much higher in frequency than the intelligence signal, the digital spreading and control signal is applied to high-pass filter 114 and the analog audio or intelligence signal is applied to the input of low-pass filter 115. The purpose of high-pass and low-pass filters 114 and 115 is to process the intelligence and spreading signals so that at the output of filters 114 and 115 the intelligence signal will not contain any signal frequency content spilling over into the spreading frequency band, nor, more importantly, will the spreading signal output provide any signal spilling over into the intelligence frequency band. FIG. 5 shows the intelligence signal frequency occupation as a result of low-pass filtering (shown at output of low-pass filter). FIG. 6 shows the spreading and control data signal frequency occupation as a resultant of both the data frequency and pattern as well as the subsequent high-pass filtering (shown at output of high-pass filter).

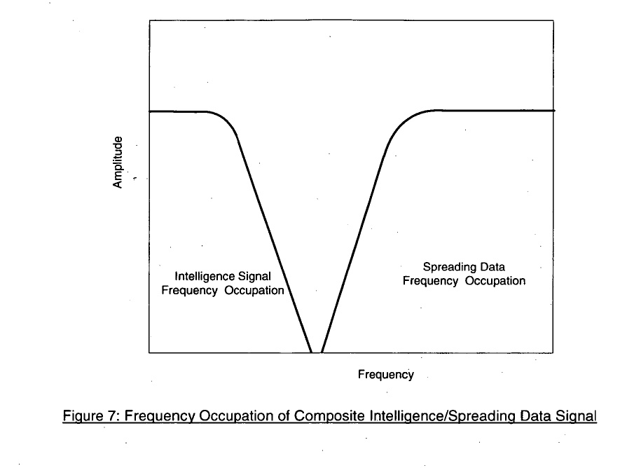

The outputs of high-pass and low-pass filters 114 and 115 are then summed at a summing device 116. Summing device 116 is a passive summing node which accomplishes the function of combining the intelligence signal (a) with the spreading and control signal (b), to form a composite intelligence/spreading signal (c). FIG. 7 illustrates the output of the summing node where the composite intelligence/spreading data signal is observed. The signals are separated in the frequency domain before they are passed into RF modulator 7.

The composite intelligence/spreading signal is next input to a RF modulator 117 for modulation onto an RF carrier. The composite intelligence/spreading signal (CISS) is modulated onto the RF carrier for the purpose of RF transmission of the intelligence information. RF modulator 117 may employ any form of linear modulation such as frequency or amplitude modulation. A local oscillator 118 determines the radio frequency that will be utilized for transmission of the CISS to a remote receiver 12.

Once remote receiver 12 receives the CISS modulated RF signal, a mixer 121 and an oscillator 122 are utilized to convert the CISS modulated RF signal down to an intermediate frequency (IF) which can then be passed to a demodulator. The IF signal is then passed through an IF filter 123. Preferably, the bandwidth of IF filter 11 must be large enough to pass the entire modulation envelope of the CISS modulated RF carrier.

After passing through IF filter 123, the IF signal is demodulated by demodulator 124. The output of demodulator 12 is the original CISS waveform.

Next, the CISS signal after demodulation is processed to recover the intelligence signal. The recovery of the intelligence signal is now possible due to the fundamental frequency separation of the intelligence and spreading data signals at the transmitter. The CISS is then passed through a low-pass filter 125 to remove any components of the spreading data signal. The resultant is the fully restored intelligence signal.

To recover the control signal contained in the spreading data signal, the CISS signal is further passed through a high-pass filter 126 so that the low frequency intelligence information is stripped out to allow the recovery of the entire spreading/control data signal channel. Through a digital device 127, which can match the known control data security code, the control data contained in the spreading/control data signal channel is therefore extracted from the spreading data stream. Once a security code match is obtained, the accompanying system control or status information can also be derived and passed to the remote device 127.

Systems and methods in accordance with an embodiment of the present invention disclosed herein can advantageously enhance a spreading signal to incorporate an intelligent data signaling channel. A digital control signal or “word” can be interleaved or substituted into the spreading data signal channel. The control data signal can be utilized to spread the lower frequency intelligence information, during this substitution interval.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM (“CD-ROM”) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

In the foregoing detailed description, systems and methods in accordance with embodiments of the present invention have been described with reference to specific exemplary embodiments. Accordingly, the present specification and figures are to be regarded as illustrative rather than restrictive. The scope of the invention is to be further understood by the numbered examples appended hereto, and by their equivalents.

What is claimed is:

1. A method for transmitting a data control signal within a spreading data channel used in a cordless telephone system, comprising:
generating the spreading data signal using a spreading generator; and
interleaving the control data channel signal into the spreading data signal to produce a spreading/control data signal,
wherein the spreading data signal is suppressed when the control data signal is interleaved into the spreading data signal and is resumed after the interleaving process is completed.

2. The method of claim 1, wherein a data switch is utilized to suppress and resume the spreading data signal.

3. The method of claim 1, wherein the data control signal has a predetermined time interval.

4. The method of claim 1, wherein the data control signal includes a pre-determined security code.

5. A method for transmitting a data control signal within a spreading data channel used in a cordless telephone system, comprising:
generating the spreading data signal using a spreading generator; and
substituting a part of the spreading data signal with the control data channel signal to produce a spreading/control data signal,
wherein the substituting is carried out periodically.

6. A method for transmitting a spreading data signal, an intelligence signal, and a control data channel signal, comprising:
generating the spreading data signal using a spreading generator;
interleaving the control data channel signal into the spreading data signal to produce a spreading/control data signal, wherein the control data channel signal has a defined time interval;
high-pass filtering the spreading/control data signal to produce a high-pass filtered spreading data/control signal;
low-pass filtering the intelligence signal to produce a low-pass filtered intelligence signal;
summing the high-pass filtered spreading and control data signal and the low-pass filtered intelligence signal to produce a composite intelligence/spreading data signal; and
modulating the composite intelligence/spreading data signal on an RF carrier.

7. A method of claim 6, wherein the control data channel signal is interleaved into the spreading data signal at periodic intervals.

8. The method of claim 7, wherein the spreading data signal is suppressed when the control data channel signal is interleaved into the spreading data signal and is resumed when the interleaving is completed.

9. The method of claim 8, wherein a data switch is utilized to suppress the spreading data signal and to allow the data control signal to be interleaved.

10. The method of claim 6, wherein the control data channel signal has a predetermined time interval.

11. The method of claim 6, wherein the control data signal contains a pre-determined security code.

12. The method of claim 6, wherein the spreading data/control data signal and the intelligence signal of the composite intelligence/spreading data signal are separate in frequency domain.

13. The method of claim 6, further comprising determining a radio frequency for transmitting the composite intelligence/spreading data signal to a remote receiver.

14. The method of claim 13, wherein the determination of the radio frequency is carried out by a local oscillator.

15. A method for receiving an intelligence signal and a control data channel signal from a composite intelligence/spreading data signal modulated RF carrier, comprising:
converting the composite intelligence/spreading data signal modulated RF carrier down to an intermediate frequency (IF) signal;
demodulating the intermediate frequency signal to retrieve a composite intelligence/spreading data signal, wherein a spreading signal in the composite spreading data includes the control data signal;
low-pass filtering the composite intelligence/spreading data signal to retrieve the intelligence signal;
high-pass filtering the composite intelligence/spreading data signal to retrieve a spreading/control data signal; and
passing the spreading/control data signal through a digital device to recover the control data channel signal.

16. The method of claim 15, wherein converting the RF carrier is carried out by a mixer and an oscillator.

17. A system for transmitting and recovering a control data signal and an intelligence signal from a composite intelligence/spreading data signal, comprising:
a data switch for receiving a spreading data and the control data signal to output a spreading data/control data signal;
a high-pass filter for filtering the spreading data/control data signal;
a low-pass filter for filtering the intelligence signal;
a summing device for summing the high-pass filtered spreading data/control data signal and the low-pass filtered intelligence signal to output a composite intelligence/spreading data signal; and
a modulator for modulating the composite intelligence/spreading data signal on a RF carrier to be transmitted to a remote receiver.

18. The system of claim 17, further comprising:
a receiver for receiving a transmitted composite intelligence/spreading data signal modulated RF carrier;
a converting device for converting the received composite intelligence/spreading data signal modulated RF carrier to an intermediate frequency (IF) signal;
a demodulator for demodulating the converted IF signal to retrieve the composite intelligence/spreading data signal; and
a high-pass filter for receiving and filtering the retrieved composite intelligence/spreading data signal to obtain the intelligence signal.

19. The system of claim 18, further comprising a low-pass filter for receiving and filtering the retrieved composite intelligence/spreading data signal to obtain the spreading data/control signal; and
a digital device, coupled with an output of the low-pass filter for retrieving the control data signal.

20. The system of claim 17, wherein the data switch suppresses the spreading data signal while interleaving the control data signal into the spreading data signal.

21. The system of claim 17, wherein the control data signal includes a pre-determined security code.

22. The system of claim 17, wherein the spreading data/control data signal and the intelligence signal of the composite intelligence/spreading data signal are separated in frequency domain.

23. The system of claim 18, wherein the converting device includes a mixer and an oscillator.

24. The system of claim 23, further comprising a IF filter coupled with the output of the mixer and oscillator for IF filtering the IF signal, wherein the IF filter is large enough to pass an entire modulation envelop of the received composite intelligence/spreading data signal modulated RF carrier.

25. The system of claim 19, wherein the digital device recovers the control data from the spreading/control data signal by matching a known control data security code with a pre-determined security code included in the control data.
